(19) United States
(12) Patent Application Publication
(10) Pub. No.: US 2022/0284314 A1
(43) Pub. Date: Sep. 8, 2022

(54) KNOWLEDGE BASED INFORMATION MODELING SERVICE PLATFORM FOR AUTONOMOUS SYSTEMS

(71) Applicant: Siemens Aktiengesellschaft, Munich (DE)

(72) Inventors: Dan Yu, Orinda, CA (US); Mareike Kritzler, San Francisco, CA (US)

(21) Appl. No.: 17/625,470

(22) PCT Filed: Jul. 9, 2019
(86) PCT No.: PCT/US2019/040972

§ 371 Date: Jan. 7, 2022

(51) Int. Cl. G06N 5/02; G05B 13/02

(52) U.S. Cl. CPC G06N 5/022; G05B 13/028

(57) ABSTRACT

A system and method for knowledge based information modeling using a semantic binding engine that generates a binding configuration based on a legacy domain semantic model extracted from a controller of an autonomous system and a knowledge graph extracted from a knowledge repository of domain knowledge related to the autonomous system. The binding configuration represents a mapping of standardized model instance components to a component of the legacy domain semantic model. An adapter with a server processes communications related to a standardized information model, including information requests that are translated to a set of process variables of the legacy domain semantic model using the binding configuration.

### TECHNICAL FIELD

This application relates to autonomous systems. More particularly, this application relates to an information modeling service platform for autonomous systems.

### BACKGROUND

Recent strides have been made in standardizing protocols for machine-to-machine cross-platform communication used for data collection and control of autonomous industrial equipment and systems. One such protocol is the Open Platform Communications (OPC) Unified Architecture (UA). Standardized information models enable interoperability between a wide range of industrial standards. Machine builders strive to migrate current products to standardized information models and to develop future products compliant with such information models.

However, in the case of OPC UA, there often lacks an alignment of existing engineering assets to OPC UA and Companion Specifications. Consequently, it is very common to see a OPC UA information model generated with no structure or context information where variables are just a mirror of the entries in the variable tables in a legacy automation engineering project. For example, an OPC UA server may directly export such a “shell” of a model using only the variable names from existing automation projects, without further effort to make the project compliant to domain relevant (e.g., OPC UA) companion specifications. Such projects are poorly situated for future digitalization or interoperability. Engineers working on upper layer systems (e.g., business management layer known as Enterprise Resource Planning (ERP) and factory management layer known as Manufacturing Execution Planning (MES)) will likely need to expend extra effort to recover and understand the meaning of the variables, therefore losing productive work time. Often times, the original context of a variable is lost, and therefore must be inferred by an engineer reading through many documents, guessing, trial or consulting with automation system engineers who may not be available. Such kind of inefficiency has become a bottleneck in converting an existing system to full digitalization and is also prone to errors and wrong decisions.

One source of the problem is the lack of proper information modeling capability in existing engineering tools. For example, FIG. 1 shows an example of an engineering tool user interface platform 101 (e.g., a Siemens Totally Integrated Automation (TIA) Portal), which includes a variable table 103 that allows a design engineer to setup process variables associated with a legacy automation system controller, such as a programmable logic controller (PLC). In this example, an engineer may be designing or modifying a control process for a legacy automation system via an OPC UA server that was introduced to the system as a recent add-on to accommodate newer components. As shown, the variables may be exported to a folder 102 on the OPC UA server. However, the engineering tool lacks the capability of attaching any additional structural/contextual information, and consequently the OPC UA server is missing the interoperability potential of standard-compliant OPC UA models.

Some tools have been developed to partially alleviate the missing link in transitioning from existing automation control oriented paradigm to a new digitalization paradigm, such as OPC UA. FIG. 2 shows an OPC UA modeling editor 231 which includes a visual tool used to modify existing information models 225 having an unknown system structure 223 for an OPC UA server 221 according to companion specifications 233, and to integrate the models with TIA projects. The editor 231 enables the engineer to manually label components of the OPC UA information model, but the label is based on decision making of engineer, and hence any added meta data have no guarantee of standard conformance. For example, a user may choose to only copy a small portion of the Companion Specification to the information model in OPC UA Server, or he may add, delete or change some variables without referencing to the Companion Specification. There is no guidance or restriction on which part to copy or which variable type/name to use.

FIG. 3 shows an example of a modelling tool for automatic conversion of existing information models to an OPC UA server source code framework. A model designer 321 may interface with information models 311, with simple functions of a GUI editor and display (e.g., add/modify objects, types or references of a UA model) to arbitrarily modify an existing model. Code generator 331 may then produce source files 341. Both solutions portrayed in FIG. 2 and FIG. 3 rely on the tool user's understanding of domain relevant standards and companion specs to build proper information models. However, these tools do not enforce compliance of the published information model to relevant standards or companion specs, nor do these tools enable users to bind relevant information of an automation system to nodes in a model representation of an OPC UA server.

### SUMMARY

Aspects according to embodiments of the present disclosure include a process and a system for knowledge based information modeling of an automation system using a service platform. The service platform may comprise multiple modules, including a semantic building engine and an adapter. The semantic binding engine may generate a binding configuration based on a semantic model extracted from a legacy model and a knowledge graph. The adapter may include a server and a translator. The server may process communications related to an information model, including information requests received from an external interface and information responses transmitted on the external interface. The communications may be formatted according to a standardized industrial protocol and the information requests relate to data associated with a controller of a legacy system. The translator may perform a translation of the information request to a legacy-based information request with reference to one or more process variables, and may send a request to the controller for obtaining the legacy-based information request, wherein the translation is based on the binding configuration.

In an embodiment, a service platform is provided with built-in semantic model of machine and skill models. In another embodiment, a service platform may be provided to generate an information model needing only a limited number of requirements, which may include selection of a machine skill (e.g., press) and a machine type (e.g., hydraulic press machine), the target protocol (e.g., OPC UA), access to an existing machine, and specifying relevant parameters and properties (e.g., maximum precision) based on the skill model.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 shows an example of variable table rendered by an engineering tool user interface platform.

FIGS. 2 and 3 illustrate examples of engineering tools for converting information models to a new digitalization paradigm.

FIG. 4 shows a system flowchart for an example of a service platform that builds a knowledge based information model of an autonomous system in accordance with one or more embodiments of this disclosure.

FIG. 5 shows an example of a binding configuration in accordance with one or more embodiments of this disclosure.

FIG. 6 shows a system flowchart for an example of runtime access to information model data in accordance with one or more embodiments of this disclosure.

FIG. 7 shows an example of an integrated system for runtime in accordance with one or more embodiments of this disclosure.

FIG. 8 shows an exemplary computing environment within which embodiments of this disclosure may be implemented.

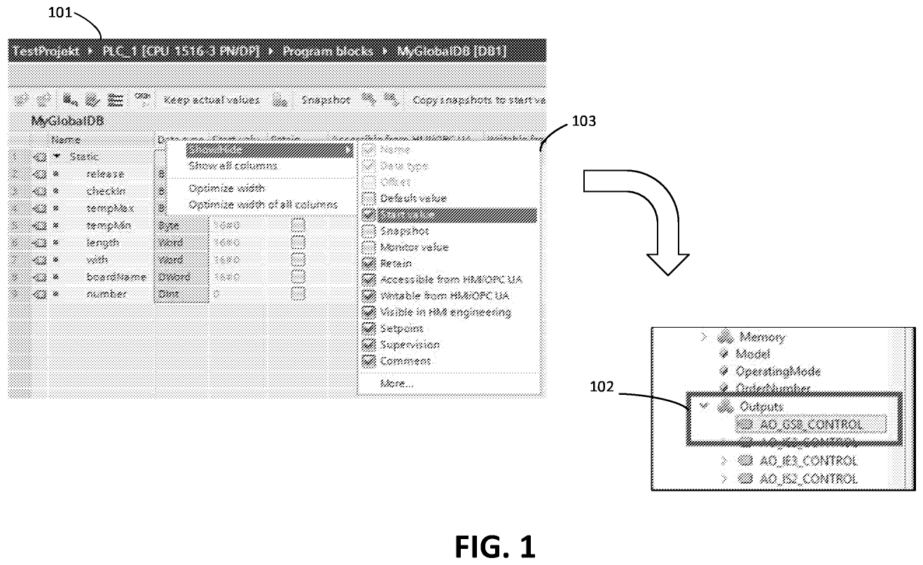

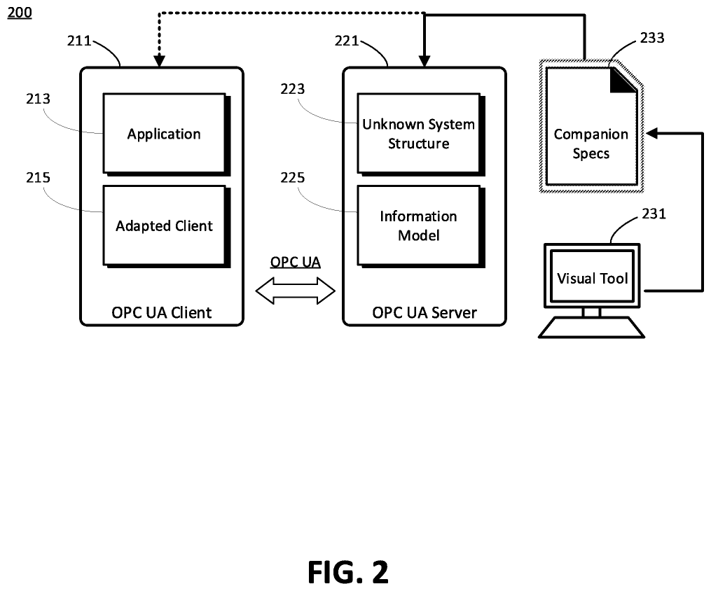

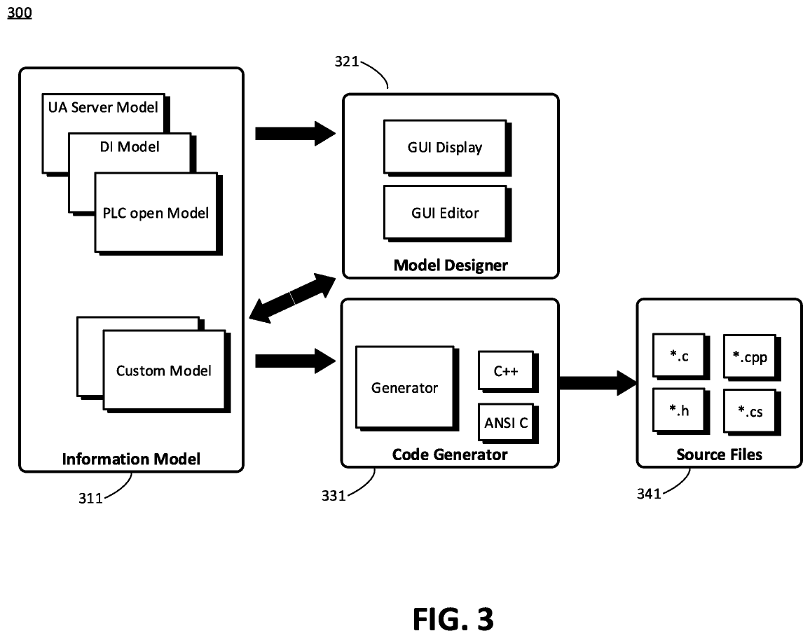

### DETAILED DESCRIPTION

Methods and systems are disclosed for using a service platform to perform information modeling of a legacy system, transforming and enrich a flat model to a more contextualized model, such as one that conforms to a standardized digitalization protocol (e.g., OPC UA). A service platform includes a semantic binding engine that generates candidate configurations for the new information model, and selects a binding configuration that maps the legacy model to the new model. The semantic binding configuration is formed by comparing an existing model extracted from a legacy system to available domain knowledge. A knowledge repository stores accumulated domain knowledge with a particular level of certainty using a machine learning process. In the semantic binding, components of the legacy system are mapped to candidate nodes of a model instance of the new information model, which may be ranked by likelihood as binding proposals, using the domain knowledge to derive likelihood. A binding configuration decision may be selected from the binding proposals based on project documentation, survey or other evidence. The effect of the disclosed methods and systems is to construct an enhanced information model with better reliability and compliance with relevant standards. Conventional approaches fail to apply system-wide historical domain knowledge to the information model, instead relying solely on the developer's knowledge, which can yield unreliable modeling. Using the disclosed service platform, a ranked set of candidates for information model instances are presented with the benefit of knowledge based machine learning.

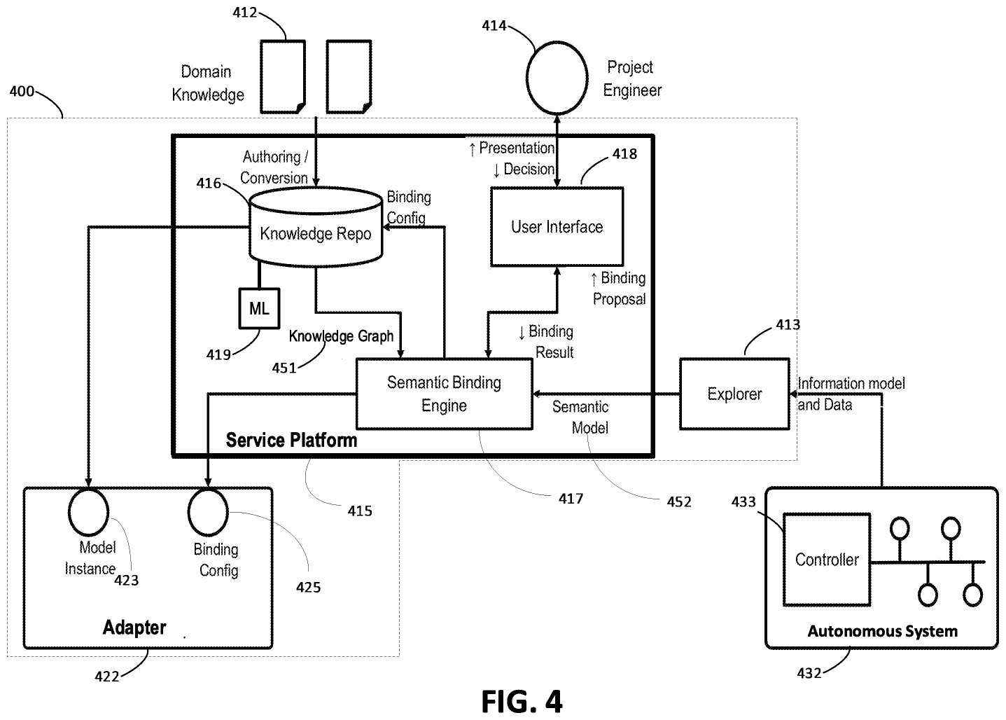

FIG. 4 shows a system flowchart for an example of a service platform that builds a knowledge based information model of an autonomous system in accordance with one or more embodiments of this disclosure. A system 400 includes a service platform 415, an adapter 422, and an explorer component 413 for modeling an autonomous system 432. In embodiment, the service platform 415 may be integrated to include the adapter 422 an explorer 413. Before an engineering phase, domain knowledge graphs may be created by converting existing domain knowledge 412, in the form of norms, standards or knowhow. Some knowledge may already have a well-defined information model (e.g. in eXtensible Markup Language (XML)), which can easily be converted to an ontology, but other knowledge may need to be curated by knowledge engineers working together with domain experts. The knowledge may also come from a natural language process (NLP) input to map unstructured manuals or documents to structured knowledge graphs. As an example of constructing a knowledge graph (e.g., a knowledge graph template) for a milling machine using NLP, know-how information may include a statement such as “all milling machines require at least one input for rotating speed (e.g., variable name “speed”) and one output for whether milling process completed successfully (e.g., variable name “success”).” The knowledge graphs may be stored in a knowledge repository 416 according to any of readily available graph database formats (e.g., Resource Description Framework (RDF)).

During an engineering phase, the explorer component 413 may be connected to a legacy autonomous system 432 to tap into an existing information model (e.g., a legacy domain information model using any industrial automation protocol) and what data is available in the stored information model. For example, explorer 413 may access an OPC UA server or a programmable logic controller (PLC). Although a standardized information model (e.g., OPC UA) template offers a rich selection of various possible layers and component types, the actual model initially constructed typically has a minimum level of information to define a model instance (i.e., a “flat” model lacking context), for lack of knowledge, time, or skill level by the engineer. For example, the legacy domain information model may include labeled or numbered variables, but without any context to help an engineer understand the association to particular system components or properties, prohibiting the generation of an OPC UA model having the full potential of context. A problem to be solved is to build an enhanced, standard-compliant information model with contextualization, allowing design integration for new projects with improved system-wide recognition of process variables, data type and methods. An example of the required translation may be in response to processing the information in a different way, such as a hierarchal connection relationship for the standard-compliant model while the legacy domain information model is organized differently (e.g., variable name alphabetized). In an embodiment, a restructuring of the legacy domain information model is executed to produce an enhanced information model that is agnostic to manufacturer of the autonomous controller 433 and resident engineering files native to the particular controller and previous engineering personnel. The enhanced information model draws from all available knowledge base sources for a broader contextualization and reliable translation to a standardized representation for a more universal functionality.

In an embodiment, the explorer 413 may extract process variables from the autonomous controller 433, generate a list of all extracted process variable data, and identify any existing structure for the process variable data, such as components and relationships. For example, a graph visualization tool may be applied to generate a graph for a semantic model to represent sensor components and motion control components tied to a particular machine in the autonomous system 432, which have interworking relationships to sensor components and motion control components associated with surrounding machines and the operational environment. In an embodiment, the explorer component 413 may identify an existing information model (e.g., a flat OPC UA model), and may convert the acquired information model into a semantic model as input for the semantic binding engine 417. For example, explorer 413 reads the legacy model and translates the information to a knowledge graph representation as the semantic model that is in a format (e.g., an intermediate format) ready for processing by the service platform 415. The explorer component 413 may be configured as a Representational State Transfer (REST) server, and may use any readily available REST framework.

The semantic binding engine 417 may compare the semantic model from the explorer 413 based on graph similarity to one or more knowledge graphs 451 from the knowledge repository 416 to determine which components and/or nodes of a standardized model (e.g., OPC UA) are likely to align with components of the autonomous system 432. In an embodiment, semantic binding engine 417 may apply textual matching (e.g., name, description, or other textual information) using one or more matching algorithms, such as fuzzy string matching or word embedding (i.e., statistical learning from existing documents). The semantic binding engine 417 may apply structural matching algorithms to hierarchal information (e.g., hasComponent, siblings, child nodes, etc.), which may apply negative exponential distance between nodes. In an embodiment, the semantic binding engine 417 may analyze components in the semantic model for accurate contextualization (e.g., determining whether a temperature value information element identified by “degrees F.” is related to a room temperature sensor or a physical device temperature sensor). In an example for which the semantic model includes OPC UA modeling, matching may be based on one or more metadata and/or model nodes (e.g., DataType, NodeClass, EngineeringUnit, etc.) using a fuzzy data type matching. For example, a process variable of room temperature measurement may be part of an information model for a precision milling machine to ensure the milling process on a work item is not adversely altered by the ambient temperature. The semantic binding engine 417 may determine the relationship based on the information from knowledge repository 416 and the semantic binding engine 417 may ensure that the semantic model includes this contextual relationship and variable context.

The comparison by the semantic binding engine 417 may be determined as a mapping function which generates a semantic binding between a library of context information of the standardized information model and components in the autonomous system 432. As an option for enhancement of mapping (e.g., in cases where some variables in a companion specification do not have a proper binding and user assistance is required to validate a variable semantic binding), candidate nodes of the standardized model instances may be sorted by likelihood according to algorithms of the semantic binding engine 417, which may be presented in the form of a binding proposal to project engineer 414 via a user interface 418 (e.g., rendered on a display). The ranking may be performed by a string matching algorithm to measure similarity of subgraphs. For example, an instance “Temperature Reading” may match a variable “Temp” better than variable “Humidity”. Additionally or alternatively, data type matching algorithm may be applied (e.g., matching a legacy domain “Int” data compatible to a standard-compliant “Float32” data).

The user interface 418 may receive inputs from the project engineer 414 related to confirmation or revision to the binding proposal, which may be based on the project documentation, survey, experience or other available domain knowhow. A binding result, such as a selection of one of the ranked candidates by the user, or a modified version of the binding proposal, may be generated from user input at the user interface 418, and then sent to the semantic binding engine 417, which generates a binding configuration 425.

The binding configuration 425 may be stored by the knowledge repository 416 as input for machine learning algorithms 419, for the purpose of providing more accurate proposals in the future. The binding configuration 425 may also be saved by the adapter 422, which includes pointers to model instance information 423 obtained from the knowledge repository 416. The adapter 422 may be configured to translate external requests during a runtime phase for access to a particular data point in the information model using a server 424 and a translator 426, to be later described below.

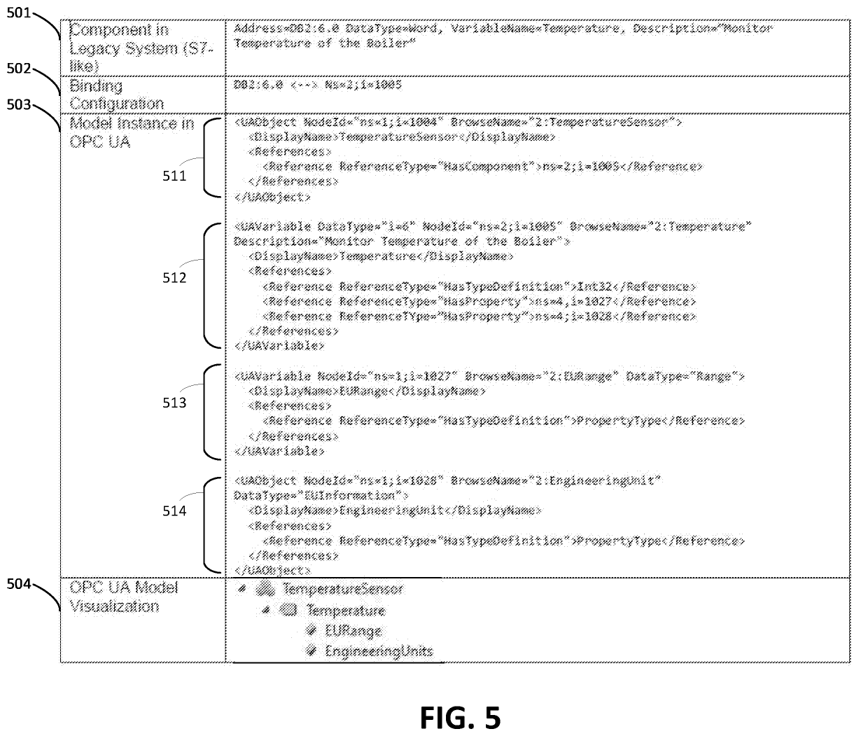

FIG. 5 shows an example of a binding configuration for a model instance in accordance with one or more embodiments of the disclosure. In an embodiment, a binding configuration 502 may be an implementation of the binding configuration 425 shown in FIG. 4. Binding configuration 502 is a mapping for a legacy database address 501 to an information model instance 503, such as a component and/or node of an OPC UA information model. In this example, the legacy database address DB2:6.0 is mapped to component Namespace 2 (Ns=2) at node ID 1005 (i=1005) in the information model. In an embodiment, the model instance 503 for the binding configuration 502 includes a rich amount of context information such as meta data. For the example shown in FIG. 5, the model instance 503 includes several components, including UA Object 511 with name “TemperatureSensor”, UA Variable 512 with name “Temperature” and description “Monitor Temperature of Boiler”, UA Variable 513 with name “Range” which provides a defined engineering unit (EU) range (e.g., a temperature range), and UA Object 514 with name “Engineering Unit”, which provides the unit for the value (e.g., degrees Celsius). An advantage of this embodiment is the automatic mapping between OPC UA and domain information models, without which, would require manual entry by project engineers (e.g., either typed in, or with help of some visual modeling tools to make the links between nodes). An example for a standardized information model visualization is shown as OPC UA Model visualization 504, which may include a hierarchal data structure, or other “user friendly” visualization for the model instance components 511, 512, 513, 514 as shown. Such a visualization may be useful during the engineering phase as binding configurations are being generated for the purpose of feedback and tracking progress.

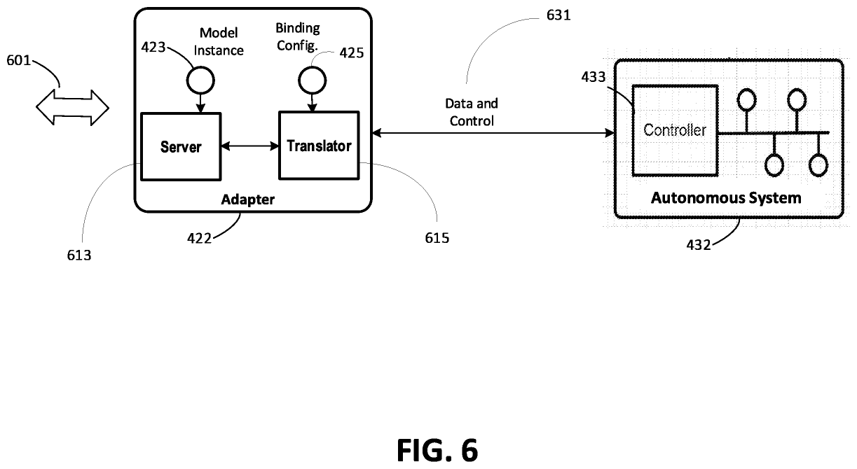

FIG. 6 shows a system flowchart for an example of runtime access to information model data in accordance with one or more embodiments of the disclosure. Adapter 422 may include a server 613 (e.g., an OPC UA server) for processing access requests for model information and a translator 615 for translating communications between the model standard (e.g., OPC UA) and model convention terminology of a legacy controller, whereby adapter 422 acts as a gateway for access to the modeled legacy system controller, and all data and control messages pass through the adapter 422. To initialize the adapter 422 for runtime operations, the server 613 may read all the stored model instances 423, which may be stored in a local memory, or stored in the knowledge repository 416 (see FIG. 4). The model instances 423 may be presented to the server 613 as an information model for allowing a user to access the model information in a useful way. For example, data of the server 613 may assist the user to determine whether additional useful metadata for a particular variable is available for a node instance of the information model.

Once initialized, the adapter 422 is ready to process information requests. An external access request to a specific data point may be received by the server 613, via external interface 601. For example, an external access request could take the form of “Requesting a temperature reading of boiler 11.” Translator 615 may translate the request from one convention (e.g., OPC UA) to another convention (e.g., the legacy autonomous system model language) according to the binding configuration 425 which maintains the mapping. The translated information may include address space, data format, unit, data type, engineering unit, and the like. The translated request may be forwarded to the controller 433 in the legacy system 432 for retrieval (e.g., real time sensor reading of boiler 11 temperature). As an example, translator 615 may receive a request that includes reference to a an OPC UA instance, then extract the legacy version of the associated variables using the binding configuration 425 mapping in a reverse mapping process. The translated request may be sent by translator 615 to legacy controller 433 using the data and control link 631. As an example, the translator 615 may recognize from the binding configuration 425 that there are three legacy variables associated with the OPC UA instance. Using the contextualization provided by the knowledge model built into the binding configuration, the information model may include a function as a standard output, such as a function of average temperature (degrees F.). As an example, the reverse mapping may be complex, such as a 1:1000 variables (e.g., an average temperature from 1000 sensors placed in the autonomous system).

The embodiments of this disclosure enable legacy systems to be aligned to an industrial standard compliant system based on standardized information models (e.g., OPC UA), companion specs, internal product conventions, and other relevant domain standards and/or norms. As a result, products and engineering solutions of associated autonomous systems may be released with higher quality and in shorter time. The added rich amount of meta information of the disclosed service platform also assists end users to automate their system integration as data can be exchanged between systems based on meaning and context, which significantly reduces expenditure of resources to link systems on a case-by-case basis.

In an embodiment, the disclosed system may be implemented as a cloud-based service platform solution residing in a cloud server. For initial deployments of the service platform, the binding proposals by semantic binding engine primarily are based on domain knowhow. As more OEM users deploy the service platform over time to align their legacy systems, the more domain knowledge is accumulated, allowing the cloud based service platform to gain further learning from various configurations obtained from the feedback of binding configurations. Hence, one advantage of the disclosed system is that it can start with basic domain knowhow and gradually build and complete the knowledge using machine learning approaches. While a pure knowledge based system is very expensive and slow to build, and a pure machine learning system requires a vast amount of data upfront, the service platform embodiments of this disclosure provide a balance between the two approaches.

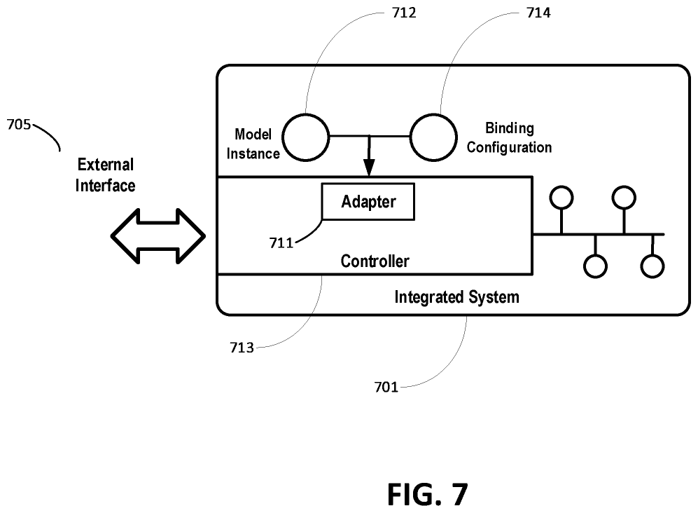

The solution presented in FIG. 4 may be implemented such that the service platform runs in the cloud. However, the service platform may alternatively run locally, which may be preferable to users with confidentiality concerns about controlling data, for example. FIG. 7 shows an example of an integrated system in accordance with embodiments of this disclosure. An integrated system 701 may deploy a built-in or embedded adapter 711 within controller 713, where the binding configuration 714 may be available to the controller 713 directly. In an embodiment, the adapter 711 may include a server and translator similar to server 613 (e.g., an OPC UA server) and translator 615 shown in FIG. 6. The integrated system 701 is able to serve external requests via external interface 705 with lower overhead and likely higher performance.

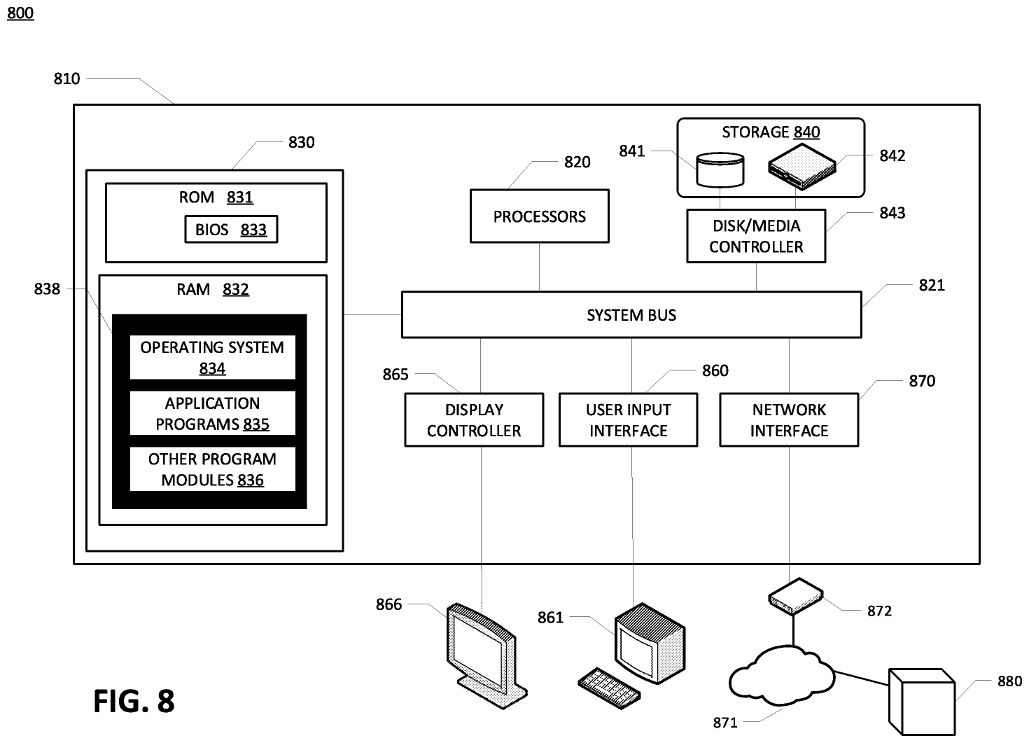

FIG. 8 shows an exemplary computing environment within which embodiments of the disclosure may be implemented. As shown in FIG. 8, the computer system 810 may include a communication mechanism such as a system bus 821 or other communication mechanism for communicating information within the computer system 810. The computer system 810 further includes one or more processors 820 coupled with the system bus 821 for processing the information.

The processors 820 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 820 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 821 may include at least one of a system bus, a memory bus, an address bus, or a message bus, and may permit exchange of information (e.g., data (including computer-executable code), signaling, etc.) between various components of the computer system 810. The system bus 821 may include, without limitation, a memory bus or a memory controller, a peripheral bus, an accelerated graphics port, and so forth. The system bus 821 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 8, the computer system 810 may also include a system memory 830 coupled to the system bus 821 for storing information and instructions to be executed by processors 820. The system memory 830 may include computer readable storage media in the form of volatile and/or nonvolatile memory, such as read only memory (ROM) 831 and/or random access memory (RAM) 832. The RAM 832 may include other dynamic storage device(s) (e.g., dynamic RAM, static RAM, and synchronous DRAM). The ROM 831 may include other static storage device(s) (e.g., programmable ROM, erasable PROM, and electrically erasable PROM). In addition, the system memory 830 may be used for storing temporary variables or other intermediate information during the execution of instructions by the processors 820. A basic input/output system 833 (BIOS) containing the basic routines that help to transfer information between elements within computer system 810, such as during start-up, may be stored in the ROM 831. RAM 832 may contain data and/or program modules 838 that are immediately accessible to and/or presently being operated on by the processors 820. System memory 830 may additionally include, for example, operating system 834, application programs 835, and other program modules 836.

The operating system 834 may be loaded into the memory 830 and may provide an interface between other application software executing on the computer system 810 and hardware resources of the computer system 810. More specifically, the operating system 834 may include a set of computer-executable instructions for managing hardware resources of the computer system 810 and for providing common services to other application programs (e.g., managing memory allocation among various application programs). In certain example embodiments, the operating system 834 may control execution of one or more of the program modules depicted as being stored in the data storage 840. The operating system 834 may include any operating system now known or which may be developed in the future including, but not limited to, any server operating system, any mainframe operating system, or any other proprietary or non-proprietary operating system.

The application programs 835 may a set of computer-executable instructions for performing the processes described above in accordance with embodiments of the disclosure.

The computer system 810 may also include a disk/media controller 843 coupled to the system bus 821 to control one or more storage devices for storing information and instructions, such as a magnetic hard disk 841 and/or a removable media drive 842 (e.g., floppy disk drive, compact disc drive, tape drive, flash drive, and/or solid state drive). Storage devices 840 may be added to the computer system 810 using an appropriate device interface (e.g., a small computer system interface (SCSI), integrated device electronics (IDE), Universal Serial Bus (USB), or FireWire). Storage devices 841, 842 may be external to the computer system 810, and may be used to store processing data in accordance with the embodiments of the disclosure.

The computer system 810 may also include a display controller 865 coupled to the system bus 821 to control a display or monitor 866, such as a cathode ray tube (CRT) or liquid crystal display (LCD), for displaying information to a computer user. The computer system includes a user input interface 860 and one or more input devices, such as a user terminal 861, which may include a keyboard, touchscreen, tablet and/or a pointing device, for interacting with a computer user and providing information to the processors 820. The display 866 may provide a touch screen interface which allows input to supplement or replace the communication of direction information and command selections by the user terminal device 861.

The computer system 810 may perform a portion or all of the processing steps of embodiments of the invention in response to the processors 820 executing one or more sequences of one or more instructions contained in a memory, such as the system memory 830. Such instructions may be read into the system memory 830 from another computer readable medium, such as the magnetic hard disk 841 or the removable media drive 842. The magnetic hard disk 841 may contain one or more data stores and data files used by embodiments of the present invention. The data store may include, but are not limited to, databases (e.g., relational, object-oriented, etc.), file systems, flat files, distributed data stores in which data is stored on more than one node of a computer network, peer-to-peer network data stores, or the like. The processors 820 may also be employed in a multi-processing arrangement to execute the one or more sequences of instructions contained in system memory 830. In alternative embodiments, hard-wired circuitry may be used in place of or in combination with software instructions. Thus, embodiments are not limited to any specific combination of hardware circuitry and software.

As stated above, the computer system 810 may include at least one computer readable medium or memory for holding instructions programmed according to embodiments of the invention and for containing data structures, tables, records, or other data described herein. The term “computer readable medium” as used herein refers to any medium that participates in providing instructions to the processors 820 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 841 or removable media drive 842. Non-limiting examples of volatile media include dynamic memory, such as system memory 830. Non-limiting examples of transmission media include coaxial cables, copper wire, and fiber optics, including the wires that make up the system bus 821. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 800 may further include the computer system 810 operating in a networked environment using logical connections to one or more remote computers, such as remote computing device 880. The network interface 870 may enable communication, for example, with other remote devices 880 or systems and/or the storage devices 841, 842 via the network 871. Remote computing device 880 may be a personal computer (laptop or desktop), a mobile device, a server, a router, a network PC, a peer device or other common network node, and typically includes many or all of the elements described above relative to computer system 810. When used in a networking environment, computer system 810 may include modem 872 for establishing communications over a network 871, such as the Internet. Modem 872 may be connected to system bus 821 via user network interface 870, or via another appropriate mechanism.

Network 871 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 810 and other computers (e.g., remote computing device 880). The network 871 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 871.

It should be appreciated that the program modules, applications, computer-executable instructions, code, or the like depicted in FIG. 8 as being stored in the system memory 830 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 810, the remote device 880, and/or hosted on other computing device(s) accessible via one or more of the network(s) 871, may be provided to support functionality provided by the program modules, applications, or computer-executable code depicted in FIG. 8 and/or additional or alternate functionality. Further, functionality may be modularized differently such that processing described as being supported collectively by the collection of program modules depicted in FIG. 8 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 8 may be implemented, at least partially, in hardware and/or firmware across any number of devices.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112(f), unless the element is expressly recited using the phrase “means for.”

What is claimed is:

1. A system for knowledge based information modeling, comprising:
at least one storage device storing a knowledge repository and computer-executable instructions configured as one or more modules; and
at least one processor configured to access the at least one storage device and execute the instructions, wherein the modules comprise:
a semantic binding engine configured to generate a binding configuration based on a legacy domain semantic model extracted from a controller of an autonomous system and a knowledge graph extracted from a knowledge repository of domain knowledge related to the autonomous system, wherein the binding configuration represents a mapping of standardized model instance components to a component of the legacy domain semantic model;
an adapter comprising:
a server for processing communications related to a standardized information model, wherein the communications include information requests received from an external interface and information responses transmitted on the external interface; wherein the information requests relate to data associated with the controller; and
a translator configured to perform a translation of each of the information requests to a set of process variables of the legacy domain semantic model, and to send a request to the controller for obtaining information of the information request, wherein the translation is based on the binding configuration.

2. The system of claim 1,
wherein the semantic binding engine and the adapter modules are deployed as a cloud based system accessing a plurality of binding configurations associated with a plurality of respective autonomous systems;
wherein the plurality of binding configurations are stored in the knowledge repository,
wherein the modules are further comprising:
a machine learning module for processing a series of binding configurations for refinement of the knowledge repository and to generate ranking of likelihood of binding proposals;
wherein the semantic binding engine updates the information model based on the refined knowledge repository and new ranking of binding proposals.

3. The system of claim 1, wherein the binding engine is further configured to:
generate a binding proposal of candidate nodes for a model instance of the standardized model sorted by likelihood according to algorithms of the binding engine;
wherein the binding configuration is based on a user selection of a candidate node.

4. The system of claim 3, wherein the binding engine is further configured to:
generate a plurality of binding configurations, each binding configuration for a respective model instance;
wherein the knowledge repository is further configured to store the plurality of binding configurations.

5. The system of claim 1, wherein during initialization of the adapter for runtime operation, the server reads a plurality of standardized model instances of respective binding configurations and presents a standardized model to assist the information requests.

6. The system of claim 1, further comprising:
an explorer component configured to extract process variable data from the controller, identify existing structure for the process variable, and convert the legacy domain information model into the legacy domain semantic model.

7. The system of claim 1, wherein the adapter is embedded in the controller.

8. A method for knowledge based information modeling, comprising:
generating, by a service platform, a binding configuration based on a legacy domain semantic model extracted from a controller of an autonomous system and a knowledge graph extracted from a knowledge repository of domain knowledge related to the autonomous system, wherein the binding configuration represents a mapping of standardized model instance components to a component of the legacy domain semantic model;
processing, by the service platform, communications related to a standardized information model, wherein the communications include information requests received from an external interface and information responses transmitted on the external interface; wherein the information requests relate to data associated with the controller; and
translating, by the service platform, each of the information requests to a set of process variables of the legacy domain semantic model, and sending a request to the controller for obtaining information of the information request, wherein the translating is based on the binding configuration.

9. The method of claim 8,
wherein the semantic binding engine and the adapter modules are deployed as a cloud based system accessing a plurality of binding configurations associated with a plurality of respective autonomous systems;
wherein the plurality of binding configurations are stored in the knowledge repository,
wherein the modules are further comprising:
a machine learning module for processing a series of binding configurations for refinement of the knowledge repository and to generate ranking of likelihood of binding proposals;
wherein the semantic binding engine updates the information model based on the refined knowledge repository and new ranking of binding proposals.

10. The method of claim 8, further comprising:
generating a binding proposal of candidate nodes for a model instance of the standardized model sorted by likelihood according to algorithms of the binding engine;
wherein the binding configuration is based on a user selection of a candidate node.

11. The method of claim 10, further comprising:
generating a plurality of binding configurations, each binding configuration for a respective model instance;
wherein the knowledge repository is further configured to store the plurality of binding configurations.

12. The method of claim 8, further comprising:
during an initialization of the service platform for runtime operation, reading a plurality of standardized model instances of respective binding configurations and presenting a standardized model to assist the information requests.

13. The method of claim 8, further comprising:
extracting process variable data from the controller, identify existing structure for the process variable, and convert the legacy domain information model into the legacy domain semantic model.
